(19) United States
(12) Patent Application Publication
(10) Pub. No.: US 2014/0112775 A1
(43) Pub. Date: Apr. 24, 2014

(54) FAN AND BEARING THEREOF

(71) Applicant: COOLER MASTER DEVELOPMENT CORPORATION, NEW TAIPEI CITY (TW)

(72) Inventor: WEI-LUNG CHAN, New Taipei City (TW)

(73) Assignee: COOLER MASTER DEVELOPMENT CORPORATION, NEW TAIPEI CITY (TW)

(21) Appl. No.: 14/058,981

(22) Filed: Oct. 21, 2013

(30) Foreign Application Priority Data
Oct. 22, 2012 (TW) 101220345

(51) Int. Cl. F16C 17/22; F04D 29/056

(52) U.S. Cl. CPC F16C 17/22; F04D 29/056
USPC 415/229; 384/278

(57) ABSTRACT

A bearing structure includes a non-metallic column-shaped main body having a through hole, an inner wall surrounding the through hole and an outer wall surrounding the inner wall. The outer wall has at least two protruding blocks extending outward and at least one groove, wherein the groove is arranged between the two neighboring protruding blocks. A fan includes a housing a stator winding, a bearing structure and a rotation piece. The housing has a base and an accommodating space. The stator winding is disposed in the accommodating space and surrounding the base. The bearing structure is disposed in the base. The rotation piece is disposed in the accommodating space, and has a rotation case, an axial shaft connected to the rotation case and a plurality of blades each connected to the rotation case.

### BACKGROUND OF THE INVENTION

1. Field of the Invention

The present disclosure relates to a fan and a bearing structure thereof; in particular, to a bearing applicable on a cooling fan and a fan and a bearing thereof which are resistant to deformity due to stress.

2. Description of Related Art

Current usage of electronic products is widespread and popular. Driven by demands, the technological development of electronic products is advancing at a rapid pace, leading to increases in processing speeds, storage capacities and associated creation of heat during high speed operation of components in electronic products. Regarding computers for example, its central processing unit (CPU) creates large amount of heat. Moreover, the efficiency of the CPU is compromised when it is at a high temperature, leading to the shutdown of the computer or more seriously damages to the same. Additionally, in order to solve the problem of electromagnetic radiation, the computer is usually enclosed in a housing. Therefore, heat dissipation of central processing units and other heat creating components is an important task.

Typically, a cooling fan and a heat sink are disposed on a CPU for dissipating heat. One side of the heat sink has a plurality of heat fins for dissipating heat from the other side of the heat sink in contact with the CPU, such that the heat can be transmitted to the tips of the heat fins and dissipated via radiation in conjunction with convection driven by the cooling fan for rapid dissipation.

FIG. 1 is a cross-sectional view of a conventional cooling fan. The cooling fan 1a includes a base 11a, a motor 12a and a fan wheel 13a. The base 11a mainly has a shaft barrel 111a, a bearing 112a enclosed in the shaft barrel 111a, and a shaft 113a passing through the bearing 112a. The motor 12a tightly fits around the shaft barrel 111a. The fan wheel is disposed on the motor 12a and the bearing 112a. The center of the fan wheel 13a aligns with the shaft 113a such that the fan wheel 13a is pivotally attached to the bearing 112a.

However, due to exposure of the cooling fan 1a to high temperature, thermal expansion causes the shaft barrel 11a to compress the bearing 112a such that the bearing 112a deforms to an extent that damages the pivoting between the bearing 112a and the shaft 113a, thereby rendering the cooling fan 1a unable to operate.

Hence, the present inventor believes the above mentioned disadvantages can be overcome, and through devoted research combined with application of theory, finally proposes the present disclosure which has a reasonable design and effectively improves upon the above mentioned disadvantages.

### SUMMARY OF THE INVENTION

The object of the present disclosure is to provide a fan and a bearing structure thereof, which do not overly deform under stress.

A bearing structure provided by one embodiment of the present disclosure includes: a non-metallic column-shaped main body having a through hole, an inner wall surrounding the through hole and an outer wall surrounding the inner wall. The outer wall has at least two protruding blocks extending outwards and at least one groove. The groove is arranged between the two neighboring protruding blocks.

A bearing structure provided by another embodiment of the present disclosure includes: a non-metallic column-shaped main body having a through hole, an inner wall surrounding the through hole and an outer wall surrounding the inner wall. One end of the outer wall proximal to the through hole has at least two first protruding blocks extending outward, and at least one first groove, and the other end of the outer wall proximal to the through hole has at least two second protruding blocks extending outward, and at least one second groove. The first groove is arranged between two neighboring first protruding blocks, and the second groove is arranged between two neighboring second protruding blocks.

A fan provided by another embodiment of the present disclosure includes: a housing, a stator winding, a bearing structure and a rotation piece. The housing has a base and an accommodating space. The stator winding is disposed in the accommodating space and surrounds the base. The bearing structure is disposed in the base. The bearing structure includes a non-metallic column-shaped main body having a through hole, an inner wall surrounding the through hole and an outer wall surrounding the inner wall. The outer wall has at least two protruding blocks extending outwards and at least one groove. The groove is arranged between the two neighboring protruding blocks. The rotation piece is disposed in the accommodating space and has a rotation case, an axial shaft connected to the rotation case and a plurality of blades each connected to the rotation case.

A fan provided by another embodiment of the present disclosure includes: a housing, a stator winding, a bearing structure and a rotation piece. The housing has a base and an accommodating space. The stator winding is disposed in the accommodating space and surrounds the base. The bearing structure is disposed in the base. The bearing structure includes a non-metallic column-shaped main body having a through hole, an inner wall surrounding the through hole and an outer wall surrounding the inner wall. One end of the outer wall proximal to the through hole has at least two first protruding blocks extending outward, and at least one first groove, and the other end of the outer wall proximal to the through hole has at least two second protruding blocks extending outward, and at least one second groove. The first groove is arranged between two neighboring first protruding blocks, and the second groove is arranged between two neighboring second protruding blocks. The rotation piece is disposed in the accommodating space and has a rotation case, an axial shaft connected to the rotation case and a plurality of blades each connected to the rotation case.

In summary of the above, the present disclosure provides a fan and a bearing structure thereof, which, through the design of “an outer wall having at least two protruding blocks extending outward and at least one groove,” do not overly deform under stress.

In order to further the understanding regarding the present disclosure, the following embodiments are provided along with illustrations to facilitate the disclosure of the present disclosure.

### BRIEF DESCRIPTION OF THE DRAWINGS

FIG. 1 shows a cross-sectional view of a conventional cooling fan;

FIG. 2A shows a perspective view of a bearing structure according to the first embodiment of the present disclosure;

FIG. 2B shows a cross-sectional view along plane 2B-2B of FIG. 2A;

FIG. 3 is a cross-sectional view of the bearing structure applied on a fan according to the first embodiment of the present disclosure;

FIG. 4A shows a perspective view of a bearing structure according the second embodiment of the present disclosure; and

FIG. 4B shows a cross-sectional view along plan 4B-4B of FIG. 4A.

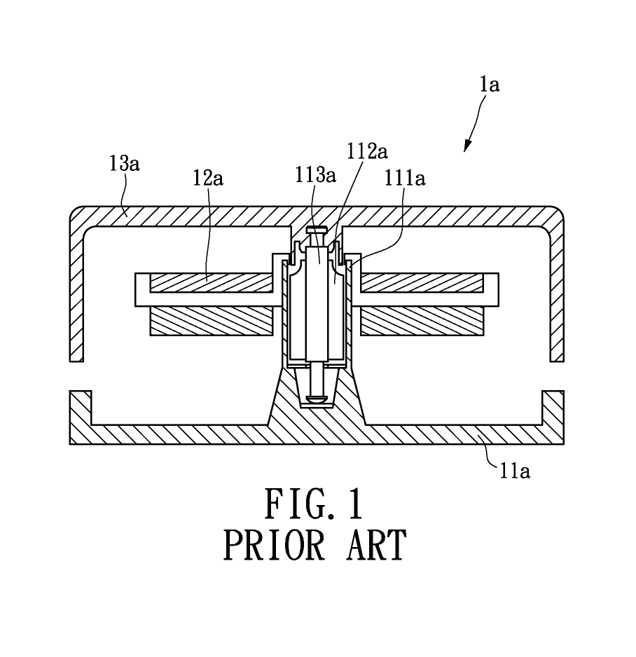

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

### First Embodiment

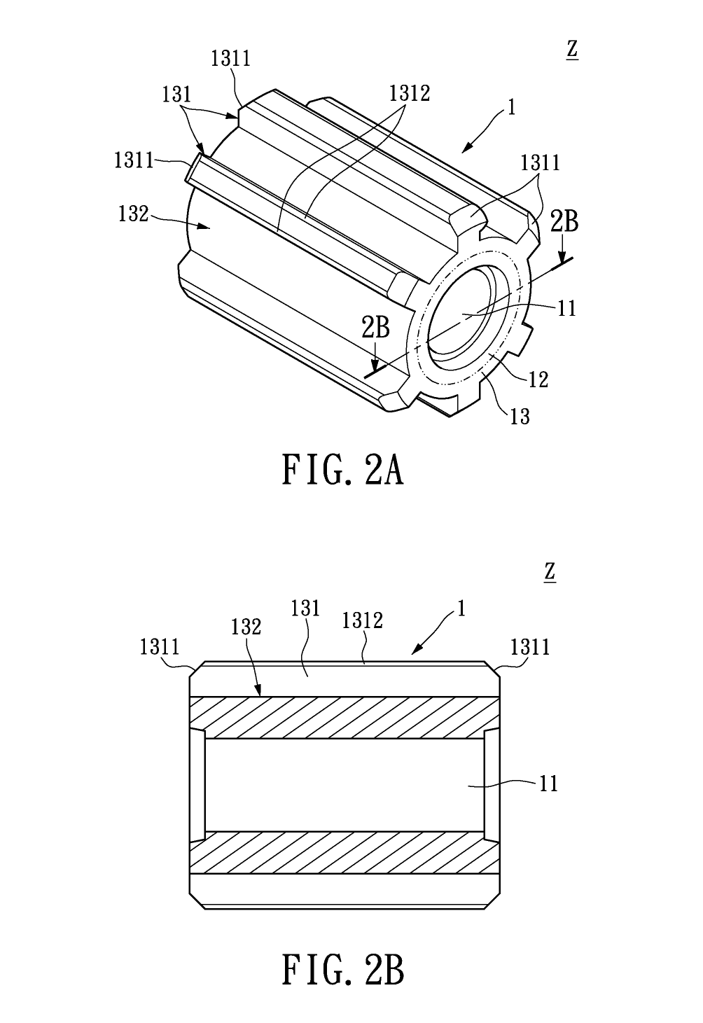

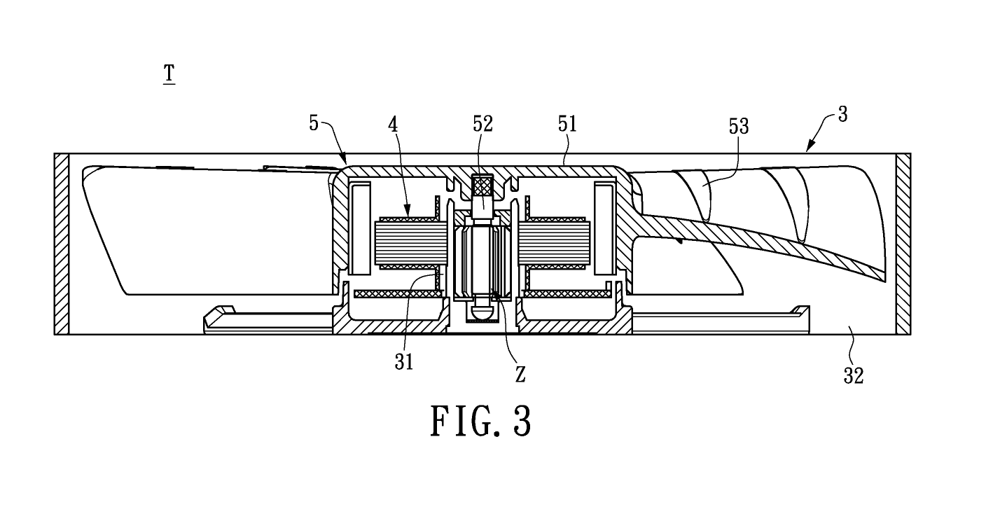

First, please refer to FIG. 2A, FIG. 2B and FIG. 3. As shown in these figures, a first embodiment of the present disclosure provides a bearing structure Z applicable on fans. The bearing structure Z includes a non-metallic column-shaped main body 1. The fan can be the fan T shown in FIG. 3 and include a housing 3, a stator winding 4, a bearing structure Z and a rotation piece 5. In the present embodiment, the non-metallic column-shaped main body 1 can be a plastic unit integrally formed as one piece.

As shown in FIG. 3, the housing 3 has a base 31 and an accommodating space 32. The stator winding 4 is disposed in the accommodating space 32 and surrounds the base 31. The bearing structure Z is disposed in the base 31. The rotation piece 5 is disposed in the accommodating space 32 and has a rotation case 51, an axial shaft 52 connected to the rotation case 51 and a plurality of blades 53 each connected to the rotation case 51. In practice, the rotation piece 5 can be a fan or an impeller.

As shown in FIG. 2A and FIG. 2B, the non-metallic column-shaped main body 1 has a through hole 11, an inner wall 12 surrounding the through hole 11 and an outer wall 13 surrounding the inner wall 12. The outer wall 13 has at least two protruding blocks 131 extending outwards and at least one groove 132. For example, the groove 132 is arranged between the two neighboring protruding blocks 131. In other words, the groove 132 is arranged parallel to the protruding blocks 131. It is worth noting that the shape or arrangement method of the groove 132 and the protruding blocks 131 can be adjusted according to practical needs, for example using a helical arrangement or a slanted arrangement.

Specifically, when the fan is operating under high temperature, the base 31 gradually expands after heating due to thermal expansion. In other words, the bearing structure Z disposed in the fan T is compressed by the surrounding base 31. However, the bearing structure Z of the present disclosure has at least one groove 132, which serves as a reserved space for thermal expansion so that when the base 31 of the fan T compresses the bearing structure Z, the presence of the groove 132 reduces the force of compression experienced by the bearing structure Z and alleviates the stress and extent of deformation in the bearing structure Z. Additionally, the fan creates less noise and operates mores smoothly.

In practice, the material of the inner wall 12 and the outer wall 13 can be plastic. Specifically, the inner wall 12 and the outer wall 13 can be a plastic unit integrally formed as one body. However, the present disclosure is not limited thereto. For example the inner wall 12 can be made of plastic while the outer wall 13 can be made of metal or plastic mixed with metal.

Additionally, each of the two ends of each of the protruding blocks 131 has a first slanted guiding face 1311, and each of the two sides of each of the protruding blocks 131 has a second slanted guiding face 1312. Specifically, due to the angles of inclination (e.g. 45 degrees) of the first slanted guiding faces 1311 and the second slanted guiding faces 1312 with respect to the top surface of the protruding block 131, the assembly of the bearing structure Z is facilitated. It is worth noting that the quantity of the first slanted guiding face 1311 and the second slanted guiding face 1312 can be increased or decreased according to need. Additionally, the angles of inclination of the first slanted guiding face 1311 and the second slanted guiding face 1312 can be adjusted according to practical need and can be different.

### Second Embodiment

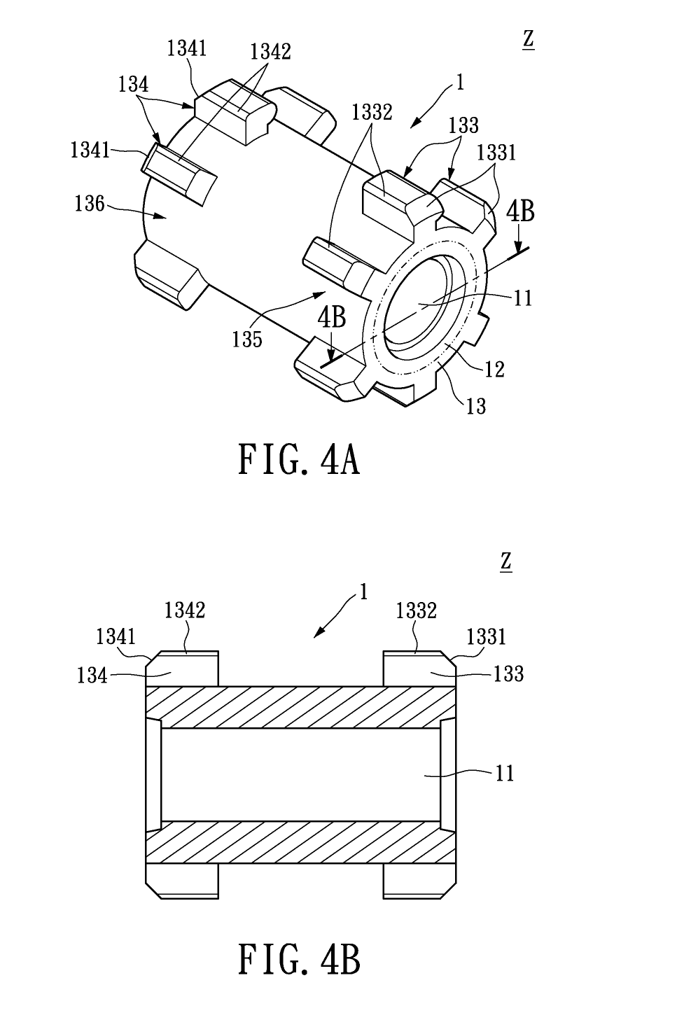

First, please refer to FIG. 4A and FIG. 4B. As shown in these figures, a second embodiment of the present disclosure provides a bearing structure Z applicable on fans. The bearing structure Z includes a through hole 11, an inner wall 12 surrounding the through hole 11 and a non-metallic column shaped main body 1 of an outer wall 13 surrounding the inner wall 12.

Comparing FIG. 4A and FIG. 2A, the difference between the second embodiment and the first embodiment lies in: in the second embodiment, one end of the outer wall 13 proximal to the through hole 11 has at least two first protruding blocks 133 extending outward, and at least one first groove 135, and the other end of the outer wall 13 proximal to the through hole 11 has at least two second protruding blocks 134 extending outward, and at least one second groove 136, wherein the first groove 135 is arranged between the two neighboring first protruding blocks 133 and the second groove 136 is arranged between the two neighboring second protruding blocks 134.

Additionally, each of the two ends of each of the first protruding blocks 133 has a first slanted guiding face 1331, and each of the two sides of each of the first protruding blocks 133 has a second slanted guiding face 1332. Each of the two ends of each of the second protruding blocks 134 has a third slanted guiding face 1341, and each of the two sides of each of the second protruding blocks 134 has a fourth slanted guiding face 1342. It is worth noting that the quantity of the first slanted guiding face 1331, the second slanted guiding face 1332, the third slanted guiding face 1341 and the fourth slanted guiding face 1342 can be increased or decreased according to need. Additionally, the angles of inclination of the first slanted guiding face 1331, the second slanted guiding face 1332, the third slanted guiding face 1341 and the fourth slanted guiding face 1342 can be adjusted according to practical need and can be different.

### Potential Advantages of the Embodiments

In summary of the above, the present disclosure provides a fan and a bearing structure thereof, which, through the design of “an outer wall having at least two protruding blocks extending outward and at least one groove,” do not overly deform under stress.

The descriptions illustrated supra set forth simply the preferred embodiments of the present disclosure; however, the characteristics of the present disclosure are by no means restricted thereto. All changes, alternations, or modifications conveniently considered by those skilled in the art are deemed to be encompassed within the scope of the present disclosure delineated by the following claims.

What is claimed is:

1. A bearing structure comprising:
a non-metallic column-shaped main body, having a through hole, an inner wall surrounding the through hole and an outer wall surrounding the inner wall, wherein the outer wall has at least two protruding blocks extending outward and at least one groove, and the grove is arranged between the two neighboring protruding blocks.

2. The bearing structure according to claim 1, wherein each of the two ends of each one of the protruding blocks has a first slanted guiding face.

3. The bearing structure according to claim 1, wherein each of the two sides of each one of the protruding blocks has a second slanted guiding face.

4. A bearing structure comprising
a non-metallic column-shaped main body, having a through hole, an inner wall surround the through hole and an outer wall surrounding the inner wall, wherein one end of the outer wall proximal to the through hole has at least two first protruding blocks extending outward, and at least one first groove, and the other end of the outer wall proximal to the through hole has at least two second protruding blocks extending outward, and at least one second groove, the first groove is arranged between the two neighboring first protruding blocks, and the second groove is arranged between the two neighboring second protruding blocks.

5. The bearing structure according to claim 4, wherein each of the two ends of each one of the first protruding blocks has a first slanted guiding face.

6. The bearing structure according to claim 4, wherein each of the two sides of each one of the first protruding blocks has a second slanted guiding face.

7. The bearing structure according to claim 4, wherein each of the two ends of each one of the second protruding blocks has a third slanted guiding face.

8. The bearing structure according to claim 4, wherein each of the two sides of each one of the second protruding blocks has a fourth slanted guiding face.

9. A fan comprising:
a housing, having a base and an accommodating space;
a stator winding disposed in the accommodating space and surrounding the base;
a bearing structure disposed in the base, wherein the bearing structure includes a non-metallic column-shaped main body having a through hole, an inner wall surrounding the through hole and an outer wall surrounding the inner wall, the outer wall has at least two protruding blocks extending outward and at least one groove, and the grove is arranged between the two neighboring protruding blocks; and
a rotation piece disposed in the accommodating space and having a rotation case, an axial shaft connected to the rotation case and a plurality of blades each connected to the rotation case.

10. The fan according to claim 9, wherein each of the two ends of each one of the protruding blocks of the bearing structure has a first slanted guiding face.

11. The fan according to claim 9, wherein each of the two sides of each one of the protruding blocks of the bearing structure has a second slanted guiding face.

12. A fan comprising:
a housing, having a base and an accommodating space;
a stator winding disposed in the accommodating space and surrounding the base;
a bearing structure disposed in the base, wherein the bearing structure includes a non-metallic column-shaped main body having a through hole, an inner wall surrounding the through hole and an outer wall surrounding the inner wall, one end of the outer wall proximal to the through hole has at least two first protruding blocks extending outward, and at least one first groove, and the other end of the outer wall proximal to the through hole has at least two second protruding blocks extending outward, and at least one second groove, the first groove is arranged between the two neighboring first protruding blocks, and the second groove is arranged between the two neighboring second protruding blocks; and
a rotation piece disposed in the accommodating space and having a rotation case, an axial shaft connected to the rotation case and a plurality of blades each connected to the rotation case.

13. The fan according to claim 12, wherein each of the two ends of each one of the first protruding blocks of the bearing structure has a first slanted guiding face.

14. The fan according to claim 12, wherein each of the two sides of each one of the first protruding blocks of the bearing structure has a second slanted guiding face.

15. The fan according to claim 12, wherein each of the two ends of each one of the second protruding blocks of the bearing structure has a third slanted guiding face.

16. The fan according to claim 12, wherein each of the two sides of each one of the second protruding blocks of the bearing structure has a fourth slanted guiding face.
